(19) United States
(12) Patent Application Publication
(10) Pub. No.: US 2018/0305863 A1
(43) Pub. Date: Oct. 25, 2018

(54) Ink-Jet Printing Process

(71) Applicants: Fujifilm Imaging Colorants, Inc., New Castle, DE (US); Fujifilm Imaging Colorants Limited, Manchester (GB)

(72) Inventors: Emmanuel Dimotakis, New Castle, DE (US); Keith Delaney, New Castle, DE (US); Christopher Oriakhi, New Castle, DE (US); Philip John Double, Manchester (GB); Ravi Shankar, New Castle, DE (US); Hamid Shirazi, New Castle, DE (US); Eda Wilson, New Castle, DE (US)

(73) Assignees: Fujifilm Imaging Colorants, Inc., New Castle, DE (US); Fujifilm Imaging Colorants Limited, Manchester, DE (GB)

(21) Appl. No.: 15/769,204

(22) PCT Filed: Oct. 14, 2016
(86) PCT No.: PCT/GB2016/000186

§ 371 Date: Apr. 18, 2018

Related U.S. Application Data
(60) Provisional application No. 62/243,347, filed on Oct. 19, 2015.

(51) Int. Cl. D06P 5/30; C09B 67/08; C09B 67/46; C09D 11/106; C09D 11/322; C09D 11/38; C09D 11/40; C09D 11/54; B41M 7/00; D06P 1/52

(52) U.S. Cl. CPC D06P 5/30; C09B 67/0013; C09B 67/009; C09D 11/106; C09D 11/322; D06P 1/5285; C09D 11/40; C09D 11/54; B41M 7/009; D06P 1/5221; D06P 1/5257; C09D 11/38

(57) ABSTRACT

A process for printing on a textile substrate comprising the steps of: (I) preparing an ink comprising the following components: (a) from 1 to 8 parts of a self-dispersible pigment which comprises a carboxy-functional dispersant crosslinked around a pigment core by a crosslinking agent having at least two groups selected from oxetane, carbodiimide, hydrazide, oxazoline, aziridine, isocyanate, N-methylol, keteneimine, isocyanurate and epoxy groups; (b) from 0 to 16 parts of a binder selected from one or more of an acrylic latex binder, a styrene acrylic latex binder and a styrene butadiene latex binder wherein the binder has a Tg in the range of from −25° C. to 35° C.; (c) from 1 to 30 parts of one or more water-miscible organic solvents (d) from 0.1 to 3 parts of a surfactant; (e) from 0 to 5 parts of biocide; (f) from 0 to 10 parts of a viscosity modifier; (g) from 0 to 10 parts of a polyurethane latex binder with a Tg in the range of from −25° C. to 35° C.; (h) from 0 to 6 parts of a cross linking agent; and (i) the balance to 100 parts water: (II) optionally preparing a latex binders solution comprising; i) from 1 to 16 parts of one or more latex binders selected from an acrylic latex binder, a styrene acrylic latex binder and a styrene butadiene latex binder where the latex binder(s) have a Tg in the range of from −25° C. to 35° C.; ii) from 0 to 6 parts of a polyurethane latex binder; and iii) from 0 to 5 parts of a cross linking agent: (III) printing the ink prepared in step (I) on to a textile substrate using a ink jet printer with a single pass print head and optionally pre-printing or overprinting with the latex binder solution from step (II) (IV) curing the printed textile substrate from step (III): provided that if component (b) in the ink prepared in step (a) is 0 then optional step (II) is compulsory. Also inks, ink-sets, ink containers and ink-jet printers.

This invention relates to a process for printing on a textile, inks for ink-jet printing, ink-jet ink containers, ink sets and printed textiles.

Ink-jet printing is a non-impact printing technique in which droplets of an ink are ejected through fine nozzles onto a substrate without bringing the nozzles into contact with the substrate. There are basically three types of ink-jet printing:
i) Continuous ink-jet printing uses a pressurized ink source that produces a continuous stream of ink droplets from a nozzle. The droplets of ink are directed either thermally or by electrostatic means at a nominally constant distance from the nozzle. Those droplets which are not successfully deflected are recycled to the ink reservoir via a gutter.
ii) Drop-on-demand ink-jet printing where the ink is stored in a cartridge and fired from the print-head nozzle using a pressurization actuator (usually thermal or piezoelectric). With drop-on-demand printing only the drops that are required for printing are produced.
iii) Single pass ink-jet printing where the ink is fired by a print head with hundreds and in some cases thousands of nozzles arranged at a high density during a single pass of the print head over the substrate. These print heads are used in industry where a high volume throughput is required. Single pass print heads may rely on ink being fed directly to the print head from an ink storage container or there may be a re-circulating single pass print head. In re-circulating single pass print heads the ink is continuously re-circulated in the print-head and (as in drop-on demand printing) only drops required for printing are drawn off to the nozzle.

Each of these types of ink-jet printing presents unique challenges. Thus, in continuous ink-jet printing ink active solvent monitoring and regulation is required to counter solvent evaporation during the time of flight of droplets which are ejected from the nozzle, but which do not give rise to a printed image (i.e. the time between nozzle ejection and gutter recycling), and from the venting process whereby excess air (drawn into the reservoir when recycling unused drops) is removed.

In drop-on demand printing the ink may be kept in the cartridge for long periods when it can deteriorate and form precipitates which can, in use, block the fine nozzles in the print-head. This problem is particularly acute with pigment inks where the suspended pigment particles can settle out.

Re-circulating ink-jet printing avoids these problems. Since the ink is constantly circulating it lessens the chance of the pigment settling and as the ink is only removed to the nozzle as required to form an image solvent evaporation is minimised.

Ink formulation for all forms of ink-jet printing is extremely demanding. It is especially difficult to formulate inks able to work in these high speed single pass print-heads. To enable these printers to work at these high speeds the inks used must show a low foaming potential and excellent drop formation.

Crucially the inks used in single pass (especially re-circulating) ink-jet printers should not cause face plate wetting of the print-head. Face plate wetting occurs when water adheres to the face plate and interferes with the jetting from one or more of the nozzles in the print-head in an industrial process this can be catastrophic since an unwanted white line can appear throughout the print output causing a complete failure of the print run with the output being discarded and the process stopped so the print head can be cleaned. This problem is particularly acute when a low film-forming temperature latex is included in the ink or printed through the print head.

Ink-jet printing of reactive dyes has found wide spread utility in the textile industry. However, ink-jet printing of pigment inks on textiles has been much more limited, due to the problems outlined above.

The applicants have found that a particular type of self-dispersible pigment in combination with certain low Tg binders are able to print satisfactorily in single pass (especially re-circulating) ink jet printers and give printed textiles which display excellent properties such as optical density, chroma, crock and wash-fastness to shade change and staining.

Thus, the present invention is concerned with a process for printing on a textile substrate comprising the steps of:
(I) preparing an ink comprising the following components:
   (a) from 1 to 8 parts of a self-dispersible pigment which comprises a carboxy-functional dispersant crosslinked around a pigment core by a crosslinking agent having at least two groups selected from oxetane, carbodiimide, hydrazide, oxazoline, aziridine, isocyanate, N-methylol, keteneimine, isocyanurate and epoxy groups;
   (b) from 0 to 16 parts of a binder selected from one or more of an acrylic latex binder, a styrene acrylic latex binder and a styrene butadiene latex binder wherein the binder has a Tg in the range of from −25° C. to 35° C.;
   (c) from 1 to 30 parts of one or more water-miscible organic solvents
   (d) from 0.1 to 3 parts of a surfactant;
   (e) from 0 to 5 parts of biocide;
   (f) from 0 to 10 parts of a viscosity modifier;
   (g) from 0 to 10 parts of a polyurethane latex binder with a Tg in the range of from −25° C. to 35° C.;
   (h) from 0 to 6 parts of a cross linking agent; and
   (i) the balance to 100 parts water:
(II) optionally preparing a latex binder solution comprising;
   i) from 1 to 16 parts of one or more latex binders selected from an acrylic latex binder, a styrene acrylic latex binder and a styrene butadiene latex binder where the latex binder(s) have a Tg in the range of from −25° C. to 35° C.;
   ii) from 0 to 6 parts of a polyurethane latex binder; and
   iii) from 0 to 5 parts of a cross linking agent:
(III) printing the ink prepared in step (I) on to a textile substrate using a ink jet printer with a single pass print head and optionally pre-printing or overprinting with the latex binder solution from step (II):
(IV) curing the printed textile substrate from step (III):
   provided that if component (b) in the ink prepared in step (a) is 0 then optional step (II) is compulsory.

All parts and percentages referred to herein, unless stated otherwise, are parts by weight.

### Step (I)

The self-dispersible pigment is preferably derived from any of the classes of pigments described in the Third Edition of the Colour Index (1971) and subsequent revisions of, and supplements thereto, under the chapter headed “Pigments”.

Examples of suitable organic pigments are those from the azo (including disazo and condensed azo), thioindigo, indanthrone, isoindanthrone, anthanthrone, anthraquinone, isodibenzanthrone, triphendioxazine, quinacridone and phthalocyanine series, especially copper phthalocyanine and its nuclear halogenated derivatives, and also lakes of acid, basic and mordant dyes. Carbon black, although often regarded as being inorganic, behaves more like an organic pigment in its dispersing properties and is also suitable. Preferred organic pigments are phthalocyanines, especially copper phthalocyanine pigments, azo pigments, indanthrones, anthanthrones, quinacridones and carbon black pigments.

The pigment is preferably a yellow, cyan, magenta, red, green, blue or black pigment. The pigment may be a single chemical species or a mixture comprising two or more chemical species (e.g. a mixture comprising two or more different pigments). In other words, two or more different pigments solids may be used in the process of the present invention. Preferably the pigment is a yellow, cyan, magenta, red, or black pigment

More preferably the self-dispersible pigment comprises one or more of Carbon Black; Pigment Blue 15:3; Pigment Blue 60; Pigment Yellow 74, Pigment Yellow 155, Pigment Red 254 and Pigment Red 122.

The dispersant, prior to crosslinking with the crosslinking agent, preferably has an acid value of at least 125 mg KOH/g.

The dispersant preferably has one or more oligomeric dispersing groups.

In order to provide water-dispersibility, the polymer-encapsulated pigment particles preferably have carboxy groups (i.e. not all of the carboxy groups in the dispersant are crosslinked to form the polymer-encapsulated pigment particles).

The polymer-encapsulated pigment particles may be prepared by crosslinking some of the carboxy groups in a carboxy-functional dispersant in the presence of a pigment and a crosslinking agent, preferably at a temperature of less than 100° C. and/or a pH of at least 6. Such crosslinking is usually performed in an aqueous medium, for example in a mixture comprising water and organic solvent. Suitable mixtures comprising water and organic solvent are as described above in relation to the ink.

Preferably, the polymer-encapsulated pigment particles have a Z-average particle size of less than 500 nm, more preferably from 10 to 400 nm and especially from 15 to 300 nm.

The Z-average particle size may be measured by any means, but a preferred method is by photo correlation spectroscopy devices available from Malvern® or Coulter®.

Preferably the carboxy-functional dispersant comprises benzyl methacrylate.

A preferred carboxy-functional dispersant is a copolymer comprising one or more hydrophobic ethylenically unsaturated monomers (preferably at least half of which by weight is benzyl methacrylate), one or more hydrophilic ethylenically unsaturated monomers having one or more carboxy groups; and optionally some or no hydrophilic ethylenically unsaturated monomers having one or more hydrophilic non-ionic groups.

An especially preferred carboxy-functional dispersant is a copolymer comprising:
(i) from 75 to 97 parts of one or more hydrophobic ethylenically unsaturated monomers comprising at least 50 parts of benzyl methacrylate;
(ii) from 3 to 25 parts of one or more hydrophilic ethylenically unsaturated monomers having one or more carboxy groups; and
(iii) 0 to 1 part of hydrophilic ethylenically unsaturated monomers having one or more hydrophilic non-ionic groups;
   wherein the parts are by weight.

Typically and the sum of the parts (i), (ii) and (iii) adds up to 100.

It is preferred that the only hydrophobic ethylenically unsaturated monomer in component (i) is benzyl methacylate.

More preferably the carboxy-functional dispersant is a copolymer comprising:
(i) from 80 to 93 parts of one or more hydrophobic ethylenically unsaturated monomers comprising at least 50 parts benzyl methacrylate;
(ii) from 7 to 20 parts of one or more hydrophilic ethylenically unsaturated monomers having one or more carboxy groups;
(iii) 0 to 1 part of hydrophilic ethylenically unsaturated monomers having a hydrophilic non-ionic group;
   wherein the parts are by weight.

Typically and the sum of the parts (i), (ii) and (iii) adds up to 100.

Preferably the hydrophobic monomers have no hydrophilic groups, whether ionic or non-ionic. For example, they are preferably free from water-dispersing groups.

Preferably, the hydrophobic ethylenically unsaturated monomers have a calculated log P value of at least 1, more preferably from 1 to 6, especially from 2 to 6.

A review by Mannhold, R. and Dross, K. (Quant. Struct-Act. Relat. 15, 403-409, 1996) describes how to calculate log P values.

Preferred hydrophobic ethylenically unsaturated monomers are styrenic monomers (e.g. styrene and alpha methyl styrene), aromatic (meth)acrylates (especially benzyl (meth)acrylate), C₁₋₃₀-hydrocarbyl (meth)acrylates, butadiene, (meth)acrylates containing poly(C₃₋₄)alkylene oxide groups, (meth)acrylates containing alkylsiloxane or fluorinated alkyl groups and vinyl naphthalene.

Preferably, the dispersant comprises the repeat units from copolymerising from 75 to 97, more preferably from 77 to 97, especially from 80 to 93 and most especially from 82 to 91 parts by weight of component (i).

Dispersants comprising at least 50 parts of benzyl (meth)acrylate monomer repeat units can provide polymer-encapsulated pigment dispersions with good stability and good optical density.

Component (i) preferably comprises at least 60 parts, more preferably at least 70 and especially at least 75 parts by weight of benzyl (meth)acylate. The remainder required to obtain the overall preferred amounts of hydrophobic monomers may be provided by any one or more of the above hydrophobic monomers other than benzyl (meth)acrylate. Preferably, benzyl (meth)acrylate is benzyl methacrylate (rather than benzyl acrylate).

In a preferred embodiment component (i) comprises only benzyl (meth)acrylate, more preferably only benzyl methacrylate.

Preferably, the monomers in component (ii) have a calculated log p value of less than 1, more preferably from 0.99 to −2, especially from 0.99 to 0 and most especially from 0.99 to 0.5, when calculated in the un-neutralised (e.g. free acid) form.

Preferred hydrophilic ethylenically unsaturated monomers for component (ii) having one or more carboxylic acid groups include beta carboxyl ethyl acrylate, itaconic acid, maleic acid, fumaric acid, crotonic acid, more preferably acrylic acid and especially methacrylic acid. Preferably, these ethylenically unsaturated monomers when polymerised provide the only ionic groups in the dispersant.

In a preferred embodiment component (ii) is or comprises methacrylic acid.

Preferably, the dispersant comprises the repeat units from copolymerising 3 to 25, more preferably 3 to 23, especially 7 to 20 and most especially 9 to 18 parts by weight of component (ii). This is especially so when component (ii) comprises, or more preferably is, methacrylic acid.

For the purposes of the present invention a monomer having both ionic and non-ionic hydrophilic groups is considered to belong to component (iii). Thus, all the ethylenically unsaturated monomers in component (ii) are free from hydrophilic non-ionic groups.

Preferably, the monomers in component (iii) have calculated log P values of less than 1, more preferably of from 0.99 to −2.

Preferably, component (iii) is less than 1 part, more preferably less than 0.5 parts, especially less than 0.1 parts and most especially 0 parts (i.e. absent). In this way the dispersant contains no repeat units from hydrophilic monomers having one or more hydrophilic non-ionic groups.

Examples of hydrophilic non-ionic groups include polyethyleneoxy, polyacrylamide, polyvinyl pyrrolidone, hydroxy functional celluloses and poly vinyl alcohol. The most common ethylenically unsaturated monomer having a hydrophilic non-ionic group is polyethyleneoxy (meth) acrylate.

In embodiments where repeat units from component (iii) are present in the dispersant (for example 1 part by weight of component (iii)) then in one embodiment the amount of component (iii) is deducted from the preferred amounts of component (i). In this way the amounts of all the components (i), (ii) and (iii) still adds up to 100. Thus for embodiments where 1 part by weight of component (iii) is present the preferred amounts of component (i) expressed above would become from 74 to 96 (75-1 to 97-1), more preferably from 76 to 96 (77-1 to 97-1), especially from 79 to 92 (80-1 to 93-1) and most especially from 81 to 90 (82-1 to 91-1) parts by weight of component (i). In an another embodiment it is possible to deduct the amount of component (iii) from the preferred amounts of component (ii) so that again the sum of the amounts of components (i), (ii) and (III) adds up to 100 parts by weight.

The function of the carboxylic acid group(s) in the dispersant is primarily to cross-link with the crosslinking agent and to provide the subsequent polymer-encapsulated pigment particles with the ability to disperse in aqueous ink media. Where carboxylic acid group(s) are the only groups for stabilising the polymer-encapsulated pigment particles in the aqueous medium it is preferable to have a molar excess of carboxylic acid groups to carboxy-reactive groups (e.g. epoxy groups) in the crosslinking agent to ensure that unreacted carboxylic acid groups remain after the crosslinking reaction has been completed. In one embodiment the ratio of moles of carboxylic acid groups to moles of carboxy-reactive groups (e.g. epoxy groups) in the crosslinking agent is preferably from 10:1 to 1.1:1, more preferably from 5:1 to 1.1:1 and especially preferably from 3:1 to 1.1:1.

The dispersant may optionally have other stabilising groups. The choice of the stabilising groups as well as the amounts of such groups will depend to a large extent on the nature of the aqueous medium.

In embodiments where the crosslinking agent has one or more oligomeric dispersing group the dispersant preferably has an acid value of at least 125 mg KOH/g.

The acid value of the dispersant, prior to crosslinking with the crosslinking agent, is preferably from 130 to 320 and more preferably from 135 to 250 mg KOH/g. We have found that dispersants having such acid values provide resultant polymer-encapsulated pigment particles which exhibit good stability in aqueous inks and also have sufficient carboxy groups for subsequent crosslinking with the crosslinking agent. Preferably, the dispersant (prior to crosslinking) has a number average molecular weight of from 500 to 100,000, more preferably from 1,000 to 50,000 and especially from 1,000 to 35,000. The molecular weight may be measured by gel permeation chromatography.

The dispersant need not be totally soluble in the liquid medium used to make the polymer-encapsulated pigment particles. That is to say perfectly clear and non-scattering solutions are not essential. The dispersant may aggregate in surfactant-like micelles giving slightly hazy solutions in the liquid medium. The dispersant may be such that some proportion of the dispersant tends to form a colloid or micellar phase. It is preferred that the dispersant produces uniform and stable dispersions in the liquid medium used to make the polymer-encapsulated pigment particles which do not settle or separate on standing.

It is preferred that the dispersant is substantially soluble in the liquid medium used to make the polymer-encapsulated pigment particles, giving rise to clear or hazy solutions.

Preferred random polymeric dispersants tend to give clear compositions whilst less preferred polymeric dispersants with two or more segments tend to give rise to the aforementioned hazy compositions in liquid media.

Typically the dispersant adsorbs onto the pigment prior to crosslinking so as to form a relatively stable dispersion of the pigment particles. This dispersion is then crosslinked using the crosslinking agent to form the polymer-encapsulated pigment particles. This pre-adsorption and pre-stabilisation in particular distinguishes the present invention from coacervation approaches whereby a polymer or pre-polymer (which is not a dispersant) is mixed with a pigment, a liquid medium and the crosslinking agent and only during or after crosslinking does the resultant cross-linked polymer precipitate onto the pigment.

In embodiments where the dispersant has an acid value of at least 125 mg KOH/g the crosslinking agent may have no oligomeric dispersing groups, but preferably the crosslinking agent has one or more oligomeric dispersing groups.

Crosslinking agents having one or more oligomeric dispersing group increase the stability of the polymer-encapsulated pigment particles in the ink.

The oligomeric dispersing group preferably is or comprises polyalkyleneoxide, more preferably a polyC₂₋₄-alkyleneoxide and especially a polyethyleneoxide. The polyalkyleneoxide groups provide steric stabilisation which improves the stability of the resulting encapsulated pigment.

Preferably the polyalkyeneoxide contains from 3 to 200, more preferably from 5 to 50 alkyleneoxide and especially from 5 to 20 alkyleneoxide repeat units.

The crosslinking agent preferably has at least two epoxy groups.

Preferred crosslinking agents having two epoxy groups and zero oligomeric dispersing groups are ethylene glycol diglycidyl ether, resorcinol diglycidyl ether, neopentyl glycol diglycidyl ether, 1,6-hexanediol diglycidyl ether, hydrogenated bisphenol A diglycidyl ether and polybutadiene diglycidyl ether.

Preferred crosslinking agents having two epoxy groups and one or more oligomeric dispersing groups are diethylene glycol diglycidyl ether, poly ethylene glycol diglycidyl ether, dipropylene glycol diglycidyl ether and poly propylene glycol diglycidyl ether.

Preferred crosslinking agents having three or more epoxy groups and zero oligomeric dispersing groups are sorbitol polyglycidyl ether, polyglycerol polyglycidyl ether, pentaerythritol polyglycidyl ether, diglycerol polyglycidyl ether, glycerol poly glycidyl ether and trimethylolpropane polygycidyl ether.

In one embodiment the epoxy crosslinking agent has zero oligomeric dispersing groups.

Examples of oxetane crosslinking agents include 1,4-bis[(3-ethyl-3-oxetanylmethoxymethyl)]benzene, 4,4′-bis[(3-ethyl-3-oxetanyl)methoxy]benzene, 1,4-bis[(3-ethy-3-oxetanyl)methoxyl-benzene, 1,2-bis[(3-ethyl-3-oxetanyl)-methoxy]benzene, 4,4-bis[(3-ethyl-3-oxetanyl)methoxy]biphenyl and 3,3′,5,5′-tetramethyl-[4,4′-bis(3-ethyl-3-oxetanyl)methoxy]biphenyl.

Examples of carbodiimide crosslinking agents include crosslinker CX-300 from DSM NeoResins. Carbodiimide crosslinking agents having good solubility or dispersibility in water may also be prepared as described in U.S. Pat. No. 6,124,398, synthetic Examples 1 to 93.

Examples of isocyanate crosslinking agents include isophorone diisocyanate, hexamethylene diisocyanate, toluene diisocyanate, methylene diphenyl diisocyanate, methylene dicyclohexyl diisocyante, 2-methyl-1,5-pentane diisocyanate, 2,2,4-trimethyl-1,6-hexane diisocyante and 1,12-dodecane diisocyanate, 1,11-diisocyanatoundecane, 1,12-diisocyanatododecane, 2,2,4- and 2,4,4-trimethyl-1,6-diisocyanatohexane, 1,3-diisocyanatocyclobutane, 4,4′-bis-(isocyanatocyclohexyl)-methane, hexamethylene diisocyanate, 1,2-bis-(isocyanatomethylycyclobutane, 1,3- and 1,4-bis-(isocyanatomethyl)cyclohexane, hexahydro-2,4- and/or -2,6-diisocyanatoluene, 1-isocyanato-2-isocyanatomethyl cyclopentane, 1-isocyanato-3-isocyanatomethyl-3,5,5-trimethyl-cyclohexane, 2,4′-dicyclohexylmethane diisocyanate, and 1-isocyanato-4(3)-isocyanatomethyl-1-methyl cyclohexane, tetramethyl-1,3- and/or -1,4-xylylene diisocyanate, 1,3- and/or 1,4-phenylene diisocyanate, 2,4- and/or 2,6-toluene diisocyanate, 2,4- and/or 4,4′-diphenyl-methane diisocyanate, 1,5-diisocyanatonaphthalene, and p-xylylene diisocyanate. Suitable diisocyanates are also understood to include those containing modification groups such as biuret, uretdione, isocyanurate, allophanate and/or carbodiimide groups, as long as they contain two or more isocyanate groups. For isocyanates the liquid medium is preferably non-aqueous, although water can sometimes be tolerated with blocked isocyanates.

In a preferred embodiment, the polyisocyanate crosslinking agent contains three isocyanate groups. A convenient source of triisocyanate functional compounds is the known isocyanurate derivative of diisocyanates. Isocyanurate derivatives of diisocyanates can be made by reacting the diisocyanate together with a suitable trimerization catalyst. An isocyanurate derivative is produced that contains an isocyanurate core with pendant organic chains terminated by three isocyanate groups. Several isocyanurate derivatives of diisocyanates are commercially available. In one preferred embodiment, the isocyanurate used is the isocyanurate of isophorone diisocyanate. In another preferred embodiment, the isocyanaurate of hexamethylene diisocyanate is used.

Examples of N-methyol crosslinking agents include dimethoxydihydroxy ethylene urea; N,N-dimethylol ethyl carbamate; tetramethylol acetylene diurea; dimethylol urone; dimethylol ethylene urea; dimethylol propylene urea; dimethylol adipic amide; and mixtures comprising two or more thereof.

Examples of keteneimine crosslinking agents include compounds of formula Ph₂C═C═N—C₆H₄—N═C═CPh₂ wherein each Ph independently is an optionally substituted phenyl group.

Examples of hydrazide crosslinking agents include malonic dihydrazide, ethylmalonic dihydrazide, succinic dihydrazide, glutaric dihydrazide, adipic dihydrazide, isophthalic dihydrazide, oxalyl dihydrazide and pimelic dihydrazide.

Commercially available highly reactive oxazoline crosslinking agents are available from, for example, Nippon Shokubai under the Epocross® trade mark. These include the emulsion type (e.g. the Epocross K-2000 Series, such as K-2010E, K-2020E and K-2030E) and the water-soluble types (e.g. the Epocross WS Series, such as WS-300, WS-500 and WS-700).

Examples of aziridine crosslinking agents include ethylene imine-based polyaziridines (e.g. PZ-28 and PZ-33 available from PolyAziridine LLC, Medford, N.J.); XC-103 tri-functional aziridines, XC-105 polyfunctional aziridines and Crosslinker XC-113 (available from Shanghai Zealchem Co., Ltd., China); polyfunctional aziridine liquid crosslinker SaC-100 (available from Shanghai UN Chemical Co., Ltd, China); The aziridines crosslinking agents disclosed in WO 2009/120420; NeoCryl® CX-100 (available from DSM NeoResins); Xama® polyfunctional aziridines (available from Lubrizol); trimethylolpropane tris(beta-aziridino)propionate, neopentylglycol di(beta-aziridino)propionate, glyceryl tris(beta-aziridino)propionate, pentaerythrityltetra(beta-aziridino)propionate, 4,4′-isopropylidenediphenol di(beta-aziridino)propionate, 4,4′-methylenediphenol di(beta-aziridino); and mixtures comprising two or more thereof.

Particularly preferred crosslinking agents are polyethylene glycol diglycidyl ether (e.g. having an average molecular weight 526, obtainable from Aldrich) and/or trimethylolpropane polyglycidyl ether (e.g. Denacol® EX-321, obtainable from Nagase Chemtex, with weight per epoxy of 140).

Preferred methods for making the self-dispersible pigment are described in WO2006/064193 and WO2010/038071. In essence, a dispersant having carboxy groups is adsorbed onto a pigment and then some (but not all) of the carboxy groups are crosslinked to give a pigment dispersion where the pigment is permanently trapped within the crosslinked dispersant. Self-dispersible pigments such as these (according to the present invention) are commercially available from FUJIFILM Imaging Colorants Limited as Pro-Jet® APD 1000 pigments and as Pro-Jet® APD 4000 pigments.

Preferably component (a) is present in a range of from 4 to 6 parts.

The ink prepared in step (I) may contain more than one acrylic, styrene acrylic latex binder and/or a styrene butadiene latex binder (component (b)). The latex binders may differ in their properties, such as particle size, glass transition temperature or molecular weight.

However, the acrylic, styrene acrylic latex binder and/or a styrene butadiene latex binder is preferably either an acrylic latex binder, styrene acrylic latex binder or a styrene butadiene latex binder.

In one preferred embodiment component (b) is an acrylic latex binder.

In a second preferred embodiment component (b) is a styrene acrylic latex binder.

In a third preferred embodiment component (b) is a styrene butadiene latex binder and more preferably a carboxylated styrene butadiene latex binder.

Preferably the acrylic, styrene acrylic latex binder and styrene butadiene latex binder has a Tg in the range of from −15° C. to 28° C. and more preferably in the range of the range of from −5° C. to 10° C.

The Tg is determined by Differential Scanning calorimetry on the dried latex. The Tg is taken as being the midpoint value from a re-heat Differential Scanning calorimetry scan (i.e. after an initial heat and cool).

Preferably the acrylic, styrene acrylic latex binder and/or a styrene butadiene latex binder are prepared by emulsion polymerisation.

The molecular weight of the acrylic, styrene acrylic latex binder and styrene butadiene latex binders can be controlled by methods known in the art, for example, by use of a chain transfer agent (e.g. a mercaptan) and/or by control of initiator concentration in the case of emulsion polymerisation, and/or by heating time. Preferably the acrylic, styrene acrylic latex binder and styrene butadiene latex binders have a molecular weight of greater than 20,000 Daltons and more preferably of greater than 100,000 Daltons. It is especially preferred that the molecular weight of the acrylic, styrene acrylic latex binder and styrene butadiene latex binders is greater than 200,000 to 500,000 Daltons.

The acrylic, styrene acrylic latex binder and styrene butadiene latex binders may be monomodal, preferably with an average particle size of below 1000 nm, more preferably below 200 nm and especially below 150 nm. Preferably, the average particle size of the acrylic, styrene acrylic latex binder and styrene butadiene latex binders is at least 20 nm, more preferably at least 50 nm. Thus, the acrylic, styrene acrylic latex binder and styrene butadiene latex binders may preferably have an average particle size in the range of from 20 to 200 nm and more preferably in the range of from 50 to 150 nm. The average particle size of the acrylic, styrene acrylic latex binder and styrene butadiene latex binders may be measured using photon correlation spectroscopy

The acrylic, styrene acrylic latex binder and styrene butadiene latex binders may also show a bimodal particle size distribution. This may be achieved either by mixing two or more latexes of different particle size, or by generating the bimodal distribution directly, for example by two-stage polymerisation. Where a bimodal particle size distribution is used it is preferred that the lower particle size peak is in the range 20-80 nm, and the higher particle size peak is in the range 100-500 nm. It is further preferred that the ratio of the two particle sizes is at least 2, more preferably at least 3 and most preferably at least 5.

The molecular weight of the acrylic, styrene acrylic latex binder and styrene butadiene latex binders may be determined by Gel Permeation Chromatography against polystyrene standards using an Agilent HP1100 instrument with THF as eluent and PL Mixed Gel C columns.

The acrylic, styrene acrylic latex binder or styrene butadiene latex binder once formed is preferably screened to remove oversized particles prior to use, for example through a filter having an average pore size below 3 μm, preferably 0.3 to 2 μm, especially 0.5 to 1.5 μm. The acrylic, styrene acrylic latex binder and styrene butadiene latex binder may be screened before, during or after it is mixed with other components to form the ink.

Commercially available acrylic, styrene acrylic latex binder and styrene butadiene latex binder may be used in the ink according to the present invention.

Examples of commercially available acrylic latexes which can be used in the ink of the pre present invention include acrylic latexes in the Rovene® range supplied by Mallard Creek polymers, particularly Rovene 6014, 6015, 6016, 6102 and 6112

Examples of commercially available acrylic, styrene acrylic latexes which can be used in the ink of the pre present invention include styrene acrylic latexes in the Rovene® range supplied by Mallard Creek polymers, particularly Rovene 6017.

Examples of commercially available styrene butadiene latexes which can be used in the ink of the pre present invention include styrene butadiene latexes in the Rovene® range supplied by Mallard Creek polymers, particularly Rovene 4180, 5550 and especially a carboxylated styrene butadiene latex such as Rovene 4107.

The acrylic, styrene acrylic latex binder and styrene butadiene latex binder cures on heating in step (IV) and so binds the pigment to the textile substrate. The curing mechanism preferably comprises the formation of internal cross-links within the acrylic latex binder, styrene acrylic latex binder or styrene butadiene latex binder. Preferably the acrylic latex binder, styrene acrylic latex binder and styrene butadiene latex binder are self cross-linking.

Component (b) is preferably present in the range of from 4 to 12 parts.

Component (c) the water-miscible organic solvent preferably comprises 1 to 3 solvents selected from the list consisting of; glycerol, 2-pyrrolidone, ethylene glycol, diethylene glycol and propylene glycol. More preferably component (b) comprises 2 or 3 solvents selected from the list consisting of; glycerol, 2-pyrrolidone, ethylene glycol and diethylene glycol. It is especially preferred that component (b) comprises glycerol, 2-pyrrolidone and ethylene glycol and diethylene glycol.

Component is (c) is preferably in the range of from 5 to 15 parts

The surfactant, component (d) is preferably an acetylenic surfactant.

Any acetylenic surfactant may be used as component (d). However, 2,4,7,9-tetramethyl-5-decyne-4,7-diol and ethylene oxide condensates thereof and 2,5,8,11-tetramethyl-6-dodecyne-5,8-diol and ethylene oxide condensates thereof are preferred.

It is particularly preferred that the acetylenic surfactant is 4,7,9-tetramethyl-5-decyne-4,7-diol or ethylene oxide condensates thereof. It is especially preferred that the acetylenic surfactant is 4,7,9-tetramethyl-5-decyne-4,7-diol. The surfactants 2,4,7,9-tetramethyl-5-decyne-4,7-diol and ethylene oxide condensates thereof are available as the Surfynol® range of surfactants from Air Products.

The preferred surfactant 2,4,7,9-tetramethyl-5-decyne-4,7-diol is commercially available as Surfynol® 440 from Air Products

Component (d) is preferably present in the composition in a range of from 0.001 to 2.5 parts, more preferably 0.01 to 1.5 parts, especially 0.05 to 1.0 parts, and more especially in a range of from 0.1 to 0.5 parts.

The surfactant is a key component in the inks of the present invention. Correct choice of both the surfactant and its concentration in a particular ink is essential in the ink-jetting effectively and in not wetting the face-plate of the print-head.

It is essential that the surfactant does not cause the ink to foam.

It is also desirable that the ink is designed so that it does not wet print-head face-plates that are not treated with a “non-wetting coating”. These face-plates may show a contact angle with water of less than 90°, or less than 80°. Face-plates that are specifically designed to be non-wetting may have a contact angle with water of more than 90° C., sometimes more than 95°, and sometimes even more than 100°.

To achieve these properties it is desirable that the ink shows a dynamic surface tension range, i.e. that its surface tension is dependent on the surface age. The surface tension of a newly created surface is high, but drops as surfactant, or other surface active species, migrate to the surface. The dynamic surface tension range may be determined by measurements in a bubble tensiometer. This measures the surface tension as a function of surface age or bubble frequency. It is preferred that the surface tension measured at 10 ms (γ(10)) is >35 dynes/cm, and the surface tension measured at 1,000 ms (γ(1000)) is in the range 20 to 40 dynes/cm, with γ(10)>γ(1000). Alternatively the equilibrium surface tension of the ink can be compared with that of the equivalent ink made without inclusion of the surfactant(s). It is preferred that the equilibrium surface tension without surfactant is at least 10 dynes/cm higher than that where the surfactant(s) is (or are) present.

For component (e) any biocide (or mixture of biocides) which is stable in the ink may be used. It is particularly preferred that the biocide comprises 1,2-benzisothazolin-3-one which is available as a 20% active solution from Lonza as Proxel® GXL and Bioban®, DXN (2,6-dimethyl-1,3-dioxan-4-yl acetate), from Dow Chemical Company.

Component (e) is preferably present in a range of 0.01 to 1.

The viscosity modifier, component (f), is preferably selected from the group consisting of polyethers, (such as polyethylene glycol and poly(ethylene oxide)), cellulose polymers such as hydroxyethyl cellulose, hydroxypropyl cellulose and carboxymethyl cellulose, water-soluble polyesters, homopolymers of 2-ethyl-oxazoline (e.g. poly-2-ethyl-2-oxazoline), poly(vinyl alcohol) and poly(vinylpyrrolidones) and mixtures thereof.

Component f) is preferably poly(ethylene glycol) or poly(ethylene oxide).

More preferably component (f) is polyethylene glycol especially polyethylene glycol 20,000.

In one preferred embodiment the viscosity modifier is present in the ink in an amount of from 3 to 8 parts.

In a second preferred embodiment the viscosity modifier is present in the ink in an amount of from 0 to 5 parts and more preferably the ink does not contain any viscosity modifier.

The ink prepared in step 1 may optionally also contain a polyurethane latex binder.

Polyurethane dispersions are typically made by:
(i) reaction of a polymeric diol (polyol), and optionally other components capable of reacting with isocyanate groups, with a di-isocyanate to create a pre-polymer, followed by;
(ii) dispersion into water optionally with chain-extension of the prepolymer by reaction with water and/or a chain-extender present in the water phase;

The dispersion may be stabilised by monomers present in the polyurethane, for example ionic groups or non-ionic groups, or by added surfactants.

The Tg of the polyurethane latex binder may be controlled through the selection of the polyol, the di-isocyanate and the chain extender. It is also possible to control the Tg of the polyurethane binder latex by mixing batches of latex with a different Tg.

Preferably the polyurethane latex binder has a Tg in the range of from −30° C. to 50° C.

The weight average molecular weight of the polyurethane is preferably >20,000, more preferably >50,000 and most preferably >100,000.

The polyurethane latex binder preferably has an average particle size of below 1000 nm, more preferably below 200 nm and especially below 150 nm. Preferably, the average particle size of the latex binder is at least 20 nm, more preferably at least 50 nm. Thus, the latex binder may preferably have an average particle size in the range of from 20 to 200 nm and more preferably in the range of from 50 to 150 nm. The average particle size of the latex binders may be measured using photon correlation spectroscopy.

Commercially available polyurethane latex binders include W835/177 and W835/397 from Incorez; Joncryl® U4190 and Joncryl 5200 from BASF; Sancure® 20025F, Sancure 2710 and XPD 3110 from Lubrizol; and Neorez R551 from DSM.

In one preferred embodiment optional component (g) is absent.

In a second preferred embodiment component (g) is present in the range of from 1 to 5 parts.

In one embodiment of the invention the latex after printing in step (III) is cross-linked by a cross linking agent during the curing step. In this case a cross-linking agent may be added to the ink (component (h)). Any suitable cross-linking agents may be used. Examples of preferred cross-linking agents are as described above for component (a).

In one preferred embodiment optional component (h) is absent.

In a particularly preferred embodiment optional components (g) and (h) are absent.

In addition to the above mentioned components, the ink composition prepared in stage 1 may also optionally comprise one or more ink additives. Preferred additives suitable for ink-jet printing inks are rheology modifiers, corrosion inhibitors and chelating agents. Preferably, the total amount of all such additives is no more than 10 parts by weight. These additives are added to and comprise part of component (i), the water added to the ink.

The water is preferably purified and particularly deionized.

In a first preferred embodiment the viscosity of the ink prepared in step 1 at 32° C. is in the range of from 10 to 14 mPa s when measured using a Brookfield DV2T with the SC4-18 spindle at 150 rpm.

In a second preferred embodiment the viscosity of the ink prepared in step 1 at 32° C. is in the range of from 4 to 8 mPas when measured using a Brookfield DV2T with the SC4-18 spindle at 150 rpm.

In the first preferred embodiment the ink prepared in step 1 has a surface tension of from 20 to 65 dynes/cm, more preferably of from 20 to 50 dynes/cm, especially of from 32 to 42 dynes/cm and more especially of from 34 to 38 dynes/cm, when measured at 25° C. using a Kruss K100 tensiometer.

In the second preferred embodiment the ink prepared in step 1 has a surface tension of from 20 to 65 dynes/cm, more preferably of from 20 to 50 dynes/cm and especially of from 30 to 40 dynes/cm, when measured at 25° C. using a Kruss K100 tensiometer.

Preferably, the ink prepared in step 1 is filtered through a filter having a mean pore size of less than 10 microns, more preferably less than 5 microns and especially less than 1 micron.

Preferably the ink has a pH in the range of from 7.5 to 9.5 and more preferably in the range of from 8.2 to 9.0. The pH may be adjusted by means of a suitable buffer.

In a first particularly preferred process the ink prepared in stage 1 comprises;
(a′) from 2 to 6 parts of a self-dispersible pigment which comprises a carboxy-functional dispersant crosslinked around a pigment core by a crosslinking agent having at least two groups selected from oxetane, carbodiimide, hydrazide, oxazoline, aziridine, isocyanate, N-methylol, keteneimine, isocyanurate and epoxy groups;
(b′) from 5 to 15 parts of an acrylic latex binder, styrene acrylic latex binder and/or styrene butadiene latex binder with a Tg in the range of from −25° C. to 35° C.
(c′) from 5 to 15 parts of one or more water-miscible organic solvents
(d′) from 0.1 to 0.5 parts of a surfactant;
(e′) from 0.01 to 1 parts of biocide;
(f′) from 3 to 8 parts of a viscosity modifier;
(g′) the balance to 100 parts water: and
   wherein the ink has a viscosity at 30° C. in the range of from 10 to 14 mPa s when measured using a Brookfield DV2T with the SC4-18 spindle at 150 rpm

In a second particularly preferred process the ink prepared in stage 1 comprises;
(a″) from 2 to 6 parts of a self-dispersible pigment which comprises a carboxy-functional dispersant crosslinked around a pigment core by a crosslinking agent having at least two groups selected from oxetane, carbodiimide, hydrazide, oxazoline, aziridine, isocyanate, N-methylol, keteneimine, isocyanurate and epoxy groups;
(b″) from 5 to 15 parts of an acrylic latex binder, styrene acrylic latex binder and/or styrene butadiene latex binder with a Tg in the range of from −25° C. to 35° C.
(c″) from 5 to 15 parts of one or more water-miscible organic solvents
(d″) from 0.1 to 0.5 parts of a surfactant;
(e″) from 0.01 to 1 parts of biocide;
(f″) from 0 to 5 parts of a viscosity modifier;
(g″) the balance to 100 parts water: and
   wherein the ink has a viscosity at 30° C. in the range of from 4 to 8 mPa s when measured using a Brookfield DV2T with the SC4-18 spindle at 150 rpm.

### Step (II)

In optional step (II) the acrylic, styrene acrylic latex binder, styrene butadiene latex binder and polyurethane latex binder are as described and preferred in Step (I)

Preferably in the process of the present invention the acrylic, styrene acrylic latex binder, styrene butadiene latex binder and polyurethane latex binder are printed onto the textile substrate as components of the ink. That is, optional step (II) is not utilised.

### Step (III)

In step (III) of the process the ink prepared in step (I), and optionally the latex binder solution prepared in step (II), is printed on to a textile substrate using a ink jet printer with a re-circulating print head.

The process of the present invention may use any ink-jet printer with a single pass print head. Preferably in step (III) the ink prepared in step (I) is printed on to a textile substrate using a ink jet printer with an ink re-circulating print-head. More preferably the ink-jet printer with an ink re-circulating print-head has an ink re-circulation channel in the ink supply system. This channel allows for fresh ink to be available for jetting and can be part of the ink supply system or even specially engineered channels which run behind the nozzle plate. It is particularly preferred that the ink supply system runs behind the nozzle plate as this allows for the use of more volatile inks whilst not compromising restart/latency behaviour. Behind nozzle plate re-circulation is exemplified in commercially available FUJIFILM Dimatix print-heads such as Samba® or SG1024®.

Re-circulating print-heads of the type preferred in the present invention are usually equipped with a reservoir heater and a thermistor to control the jetting temperature. Preferably in step (III) the jetting temperature is in excess of 30° C.

Preferably the drop volume of the ink applied by the ink-jet printer is in the range of from 1 to 100 pl.

When the ink of the first preferred embodiment, as described above in step (I) is jetted the drop volume of the ink applied by the ink-jet printer is preferably in the range of from 20 to 100 pl and more preferably in the range of from 20 to 40 pl and especially of from 25 to 35 pl.

When the ink of the second preferred embodiment, as described above in step (I) is jetted the drop volume of the ink applied by the ink-jet printer is preferably in the range of from 1 to 20 pl and more preferably in the range of from 2 to 8 pl.

In step (III) the ink prepared in step (I) may be printed onto any suitable textile substrate.

The textile substrate may comprise natural or synthetic fibers including blends thereof.

Thus, the textile substrate may comprise cotton, cellulose, including viscose rayon and regenerated viscose rayon, wool, acrylic, polyamide such as nylon, polyester such as polyethyleneglycolterephthalate or polyurethane.

Preferably the textile substrate comprises cotton or a blend thereof.

The textile substrate is preferably woven or knitted or in the form of dry or wet-laid fibers. It may be in the form of sheets, webs, threads or ready made up garments such as drapes, shirting, toweling, underwear, socks and sheeting.

The textile substrate may be printed without any pretreatment. However, in some circumstances a pretreatment may be required. The exact pretreatment will depend on the nature of the textile substrate and will be well known to a person skilled in the art.

### Step (IV)

In step (IV) of the process of the present invention any curing mechanism may be utilized. However, it is preferred that the textile substrate printed in step (III) is heat cured.

Any means of heat curing may be utilized though preferably the textile substrate is cured by a method comprising infra-red and/or hot air.

A particular advantage of the present invention is that the textile substrate can be cured at a low temperature. Thus, it is preferred that in step (IV) the printed textile substrate is cured for 5 minutes or less and more preferably for 2 minutes or less at a temperature below 160° C., more preferably below 125° C. The exact temperature and exposure time used in the heat curing process will also, of course, depend on the nature and properties of the printed textile substrate.

Preferably the mechanism of curing comprises the formation of internal cross-links within the acrylic latex binder, styrene acrylic latex binder and styrene butadiene latex binder. More preferably the acrylic latex binder, styrene acrylic latex binder and styrene butadiene latex binder are self cross-linking.

The method for printing of the present invention may also comprise one of more drying steps prior to curing.

Drying may be carried out by any suitable means. Preferably drying is carried out using a air-velocity to achieve substrate temperature between 60-120° C. Medium wavelength-IR or near-IR drying and hybrid drying technologies may also be used.

One preferred embodiment uses medium wavelength IR dryer/impinged air and/or a hot air combination.

The process of the present invention may further comprise additional textile processing steps such as the application of additional finishes. These finishes are designed to give particular properties to the final form of the substrate such as rendering it antistatic, fire resistant or antimicrobial.

In a preferred process according to the invention Step (III) and Step (IV) are carried out in-line.

According to a second aspect of the invention there is provided an ink comprising
(a′) from 2 to 6 parts of a self-dispersible pigment which comprises a carboxy-functional dispersant crosslinked around a pigment core by a crosslinking agent having at least two groups selected from oxetane, carbodiimide, hydrazide, oxazoline, aziridine, isocyanate, N-methylol, keteneimine, isocyanurate and epoxy groups;
(b′) from 0 to 16 parts of a binder selected from one or more of an acrylic latex binder, a styrene acrylic latex binder and a styrene butadiene latex binder wherein the binder has a Tg in the range of from −25° C. to 35° C.;
(c′) from 5 to 15 parts of one or more water-miscible organic solvents
(d′) from 0.1 to 0.5 parts of a surfactant;
(e′) from 0.01 to 1 parts of biocide;
(f′) from 3 to 8 parts of a viscosity modifier;
(g′) the balance to 100 parts water: and wherein the ink
   wherein the ink has a viscosity at 30° C. in the range of from 10 to 14 mPa s when measured using a Brookfield DV2T with the SC4-18 spindle at 150 rpm

The components in the ink in the second aspect of the invention are as described and preferred in the first aspect of the invention.

According to a third aspect of the invention there is provided an ink comprising
(a″) from 2 to 6 parts of a self-dispersible pigment which comprises a carboxy-functional dispersant crosslinked around a pigment core by a crosslinking agent having at least two groups selected from oxetane, carbodiimide, hydrazide, oxazoline, aziridine, isocyanate, N-methylol, keteneimine, isocyanurate and epoxy groups;
(b″) from 0 to 16 parts of a binder selected from one or more of an acrylic latex binder, a styrene acrylic latex binder and a styrene butadiene latex binder wherein the binder has a Tg in the range of from −25° C. to 35° C.;
(c″) from 5 to 15 parts of one or more water-miscible organic solvents
(d″) from 0.1 to 0.5 parts of a surfactant;
(e″) from 0.01 to 1 parts of biocide;
(f″) from 0 to 5 parts of a viscosity modifier;
(g″) the balance to 100 parts water: and
   wherein the ink has a viscosity at 30° C. in the range of from 4 to 8 mPa s when measured using a Brookfield DV2T with the SC4-18 spindle at 150 rpm.

The components in the ink in the third aspect of the invention are as described and preferred in the first aspect of the invention.

According to a fourth aspect of the invention there is provided a textile substrate printed by a process as described in the first aspect of the invention or with an ink as described in the second or third aspect of the invention. The textile substrate is as described and preferred in the first aspect of the invention.

According to a fifth aspect of the present invention there is provided an ink-jet printer ink container (such as a cartridge or a larger ink tank), comprising an ink as described in the second or third aspects of the present invention

A sixth aspect of the present invention provides an ink-jet printer with a re-circulating printer head, as described in the first aspect of the invention, containing an ink-jet printer ink container as described in the fifth aspect of the invention.

A seventh aspect of the invention provides an ink-set comprising two or more different coloured inks as described and preferred in either the second or third aspects of the invention. The ink-set of the seventh aspect of the invention may contain inks other than those defined and described in the second and third aspects of the invention.

In one preferred embodiment the seventh aspect of the invention comprises an ink-set comprising a black ink, a cyan ink, a yellow ink and a magenta ink wherein the inks are as described and preferred in the second aspect of the invention. Preferably the pigment in the black ink is carbon black; the pigment in the cyan ink is Pigment Blue 15:3; the pigment in the yellow ink is Pigment Yellow 74 or Pigment Yellow 155; and the pigment in the magenta ink is Pigment Red 122.

Another preferred embodiment of the seventh aspect of the invention provides an ink set comprising a black ink, a cyan ink, a yellow ink, a magenta ink, a blue ink and a red ink and optionally an orange ink, a light cyan ink, a light magenta ink or a white ink wherein the inks are as described in either the second or the third aspect of the present invention. In this ink set the pigment in the black ink is carbon black; the pigment in the cyan ink is Pigment Blue 15:3; the pigment in the yellow ink is Pigment Yellow 74 or Pigment Yellow 155; the pigment in the magenta ink is Pigment Red 122; the pigment in the blue ink is Pigment Blue 60; the pigment in the red ink is Pigment Red 254 and the pigment in the white ink is titanium dioxide.

### EXAMPLES

The present invention will now be illustrated by the following examples in which all parts are by weight unless stated to the contrary.

### Example 1

The present invention will now be illustrated by the following examples in which all parts are by weight unless stated to the contrary.

The self-dispersible pigment used was Pro-Jet® APD 1000 Black. Identical inks may be prepared using Pro-Jet® APD 1000 Cyan, Magenta and Yellow. The Pro-Jet® APD 1000 pigment dispersions are available from FUJIFILM Imaging Colorants Limited.

Surfynol® 440 is an acetylenic surfactant from Air Products.

Rovene® 4170 is a styrene butadiene dispersion from Mallard Creek Polymers. The Tg of Rovene 4170 is 4° C. and the acid number is 50 mgKOH/g.

1,2-Benzisothazolin-3-one was obtained as Proxel® GXL (20% solution) from Lonza.

### Example 1—Black Ink

| Component | Formulation At 100% Active (Wt %) |
|---|---|
| Pro-Jet Black ADP 4000 | 4.00 |
| Glycerol | 3.75 |
| Ethylene glycol | 1.25 |
| 2 Pyrrolidone 95% | 5.00 |
| Surfynol 440 | 0.33 |
| 1,2-Benzisothazolin-3-one | 0.02 |
| Rovene 4170 | 8.00 |
| PEG 20K | 5.20 |
| DI Water | to 100 |
| Properties | |
| pH | 8.51 |
| Viscosity at 32° C. mPs | 12.46 |
| Surface Tension D/cm | 35.68 |

### Example 2—Cyan Ink

| Component | Formulation At 100% Active (Wt %) |
|---|---|
| Pro-Jet Cyan ADP 4000 | 4.00 |
| Glycerol | 3.75 |
| Ethylene glycol | 1.25 |
| 2 Pyrrolidone 95% | 5.00 |
| Surfynol 440 | 0.32 |
| 1,2-Benzisothazolin-3-one | 0.02 |
| Rovene 4170 | 8.00 |
| PEG 20K | 6.30 |
| DI Water | to 100 |
| Properties | |
| pH | 8.56 |
| Viscosity at 32° C. mPs | 12.26 |
| Surface Tension D/cm | 36.05 |

### Example 3—Magenta Ink

| Component | Formulation At 100% Active (Wt %) |
|---|---|
| Pro-Jet Magenta ADP 4000 | 4.00 |
| Glycerol | 3.75 |
| Ethylene glycol | 1.25 |
| 2 Pyrrolidone 95% | 5.00 |
| Surfynol 440 | 0.32 |
| 1,2-Benzisothazolin-3-one | 0.02 |
| Rovene 4170 | 8.00 |
| PEG 20K | 6.40 |
| DI Water | to 100 |
| Properties | |
| pH | 8.67 |
| Viscosity at 32° C. mPs | 12.98 |
| Surface Tension D/cm | 35.82 |

### Example 4—Yellow Ink

| Component | Formulation At 100% Active (Wt %) |
|---|---|
| Pro-Jet Yellow ADP 1000 | 4.00 |
| Glycerol | 3.75 |
| Ethylene glycol | 1.25 |
| 2 Pyrrolidone 95% | 5.00 |
| Surfynol 440 | 0.33 |
| 1,2-Benzisothazolin-3-one | 0.02 |
| Rovene 4170 | 8.00 |
| PEG 20K | 6.00 |
| DI Water | to 100 |
| Properties | |
| pH | 8.67 |
| Viscosity at 32° C. mPs | 12.68 |
| Surface Tension D/cm | 35.87 |

### Example 5—Red Ink

| Component | Formulation At 100% Active (Wt %) |
|---|---|
| Pro-Jet Red ADP 1000 | 4.00 |
| Glycerol | 3.75 |
| Ethylene glycol | 1.25 |
| 2 Pyrrolidone 95% | 5.00 |
| Surfynol 440 | 0.35 |
| 1,2-Benzisothazolin-3-one | 0.02 |
| Rovene 4170 | 8.00 |
| PEG 20K | 6.00 |
| DI Water | to 100 |
| Properties | |
| pH | 8.67 |
| Viscosity at 32° C. mPs | 12.82 |
| Surface Tension D/cm | 35.71 |

### Example 6—Blue Ink

| Component | Formulation At 100% Active (Wt %) |
|---|---|
| Pro-Jet Black ADP 4000 | 4.00 |
| Glycerol | 3.75 |
| Ethylene glycol | 1.25 |
| 2 Pyrrolidone 95% | 5.00 |
| Surfynol 440 | 0.32 |
| 1,2-Benzisothazolin-3-one | 0.02 |
| Rovene 4170 | 8.00 |
| PEG 20K | 6.40 |
| DI Water | to 100 |
| Properties | |
| pH | 8.66 |
| Viscosity at 32° C. mPs | 12.88 |
| Surface Tension D/cm | 35.41 |

The ink was printed through a StarFire® SG1024 re-circulating print head from FUJIFILM Dimatix. The StarFire® SG1024 re-circulating print head is commonly only used with non-aqueous inks due to a tendency of its face plate to “wet” when used with aqueous inks, thus adversely effecting printer performance.

However the example inks printed without any problems. The print head was photographed with a JetXpert drop watcher. There was no evidence of any face plate wetting with the ink of the present invention.

The inks described above were also printed onto a range of textile substrates including acetate, cotton, nylon, polyester, acrylic and wool and assessed by the following American Association of Textile Chemists and Colorists (AATCC) Standards.
Colorfastness to laundering/washing—AATCC 61
Colorfastness to light—AATCC 16
Colorfastness to crocking—AATCC 116
Colorfastness to dry-cleaning—AATCC 132

Cotton and a cotton polyester blend were printed by a process according to the present invention and assessed using the AATCC tests outlined above. The results are shown in Tables 1 and 2.

In Table 1 and 2 colorfastness to laundering/washing, colorfastness to crocking and colorfastness to dry-cleaning were all scored on a relative scale of 1 to 5 where 1 was poor and 5 excellent. Colorfastness to light was assessed on a relative scale of 1 to 8 where 1 was poor and 8 excellent.

In all of these tests substrates printed by a process of the present invention showed outstanding properties.

In all of these tests the textile substrates printed with inks, described above, by a process according to the present invention displayed excellent properties.

TABLE 1

| Ink Name | | | Black | Cyan | Magenta | Yellow | Blue | Red |
|---|---|---|---|---|---|---|---|---|
| Cotton | Washfastness | Shade | 4 | 4 | 4 | 4 | 4 | 4 |
| | AATCC 61 | Change | | | | | | |
| | (ISO105-C06) | Color | | | | | | |
| | (49° C.-2A) | Transfer | | | | | | |
| | | Acetate | 4-5 | 4-5 | 4-5 | 4-5 | 5 | 4-5 |
| | | Cotton | 4-5 | 4 | 4 | 4 | 4 | 4-5 |
| | | Nylon | 5 | 4-5 | 5 | 4-5 | 4-5 | 4-5 |
| | | Polyester | 5 | 4-5 | 4-5 | 4-5 | 4-5 | 4-5 |
| | | Acrylic | 4-5 | 4-5 | 4-5 | 4-5 | 4-5 | 4-5 |
| | | Wool | 4-5 | 4-5 | 4-5 | 4-5 | 4-5 | 4-5 |
| | Colorfastness to | Shade | 4-5 | 4-5 | 4-5 | 4-5 | 4-5 | 4-5 |
| | drycleaning | Change | | | | | | |
| | AATCC 132 | Color | | | | | | |
| | (ISO105-D01) | Transfer | | | | | | |
| | | Acetate | 5 | 4 | 5 | 4-5 | 4 | 4-5 |
| | | Cotton | 5 | 4-5 | 5 | 4-5 | 4-5 | 4-5 |
| | | Nylon | 5 | 4-5 | 4-5 | 4-5 | 4-5 | 4-5 |
| | | Polyester | 5 | 4-5 | 5 | 4-5 | 4-5 | 4-5 |
| | | Acrylic | 5 | 4 | 5 | 4 | 3 | 4 |
| | | Wool | 5 | 4-5 | 5 | 4-5 | 4-5 | 4-5 |
| | Crockfastness | Dry | 4-5 | 4-5 | 4 | 4-5 | 4-5 | 4-5 |
| | (AATCC 116) | Wet | 3-4 | 3 | 3 | 3-4 | 3-4 | 3 |
| | (ISO105-X16) | | | | | | | |
| | Lightfastness AATC | Blue Scale | 7 | 7 | 7 | 7 | 7 | 7 |
| | 16 (ISO 105-B02) | Grading 1-8 | | | | | | |

TABLE 2

| Ink Name | | | Black | Cyan | Magenta | Yellow | Blue | Red |
|---|---|---|---|---|---|---|---|---|
| Cotton- | Washfastness | Shade | 4 | 4 | 4 | 4 | 4 | 4 |
| Polyester | AATCC 61 | Change | | | | | | |
| Blend | (ISO105-C06) | Color | | | | | | |
| | (49° C.-2A) | Transfer | | | | | | |
| | | Acetate | 4-5 | 5 | 5 | 5 | 5 | 4-5 |
| | | Cotton | 4-5 | 4-5 | 4-5 | 4-5 | 4-5 | 4-5 |
| | | Nylon | 5 | 4-5 | 5 | 5 | 4-5 | 4-5 |
| | | Polyester | 4-5 | 4-5 | 5 | 5 | 5 | 4-5 |
| | | Acrylic | 4-5 | 4-5 | 4-5 | 5 | 5 | 4-5 |
| | | Wool | 4-5 | 4-5 | 4-5 | 4-5 | 4-5 | 4-5 |
| | Colorfastness to | Shade | 4-5 | 4-5 | 4-5 | 4-5 | 4-5 | 4-5 |
| | drycleaning | Change | | | | | | |
| | AATCC 132 | Color | | | | | | |
| | (ISO105-D01) | Transfer | | | | | | |
| | | Acetate | 5 | 5 | 4-5 | 4-5 | 4-5 | 5 |
| | | Cotton | 5 | 5 | 4-5 | 4-5 | 4-5 | 4-5 |
| | | Nylon | 5 | 4-5 | 4-5 | 4-5 | 4-5 | 4-5 |
| | | Polyester | 5 | 5 | 4-5 | 4-5 | 4-5 | 4-5 |
| | | Acrylic | 5 | 5 | 4-5 | 4-5 | 4-5 | 4 |
| | | Wool | 5 | 5 | 5 | 4-5 | 4-5 | 4-5 |
| | Crockfastness | Dry | 4-5 | 4-5 | 4-5 | 4-5 | 4-5 | 4-5 |
| | (AATCC 116) | Wet | 3 | 3-4 | 3 | 3-4 | 3-4 | 3-4 |
| | (ISO105-X16) | | | | | | | |
| | Lightfastness AATC | Blue Scale | 7 | 7 | 7 | 7 | 7 | 7 |
| | 16 (ISO 105-B02) | Grading 1-8 | | | | | | |

1. A process for printing on a textile substrate comprising the steps of:
(I) preparing an ink comprising the following components:
(a) from 1 to 8 parts of a self-dispersible pigment which comprises a carboxy-functional dispersant crosslinked around a pigment core by a crosslinking agent having at least two groups selected from oxetane, carbodiimide, hydrazide, oxazoline, aziridine, isocyanate, N-methylol, keteneimine, isocyanurate and epoxy groups;
(b) from 0 to 16 parts of a binder selected from one or more of an acrylic latex binder, a styrene acrylic latex binder and a styrene butadiene latex binder wherein the binder has a Tg in the range of from −25° C. to 35° C.;
(c) from 1 to 30 parts of one or more water-miscible organic solvents
(d) from 0.1 to 3 parts of a surfactant;
(e) from 0 to 5 parts of biocide;
(f) from 0 to 10 parts of a viscosity modifier;
(g) from 0 to 10 parts of a polyurethane latex binder with a Tg in the range of from −25° C. to 35° C.;
(h) from 0 to 6 parts of a cross linking agent; and
(i) the balance to 100 parts water:
(II) optionally preparing a latex binders solution comprising;
i) from 1 to 16 parts of one or more latex binders selected from an acrylic latex binder, a styrene acrylic latex binder and a styrene butadiene latex binder where the latex binder(s) have a Tg in the range of from −25° C. to 35° C.;
ii) from 0 to 6 parts of a polyurethane latex binder; and
iii) from 0 to 5 parts of a cross linking agent:
(III) printing the ink prepared in step (I) on to a textile substrate using a ink jet printer with a single pass print head and optionally pre-printing or overprinting with the latex binder solution from step (II)
(IV) curing the printed textile substrate from step (III):
provided that if component (b) in the ink prepared in step (a) is 0 then optional step (II) is compulsory.

2. The process as claimed in claim 1 wherein component (b) is a styrene butadiene latex binder.

3. The process as claimed in claim 2 wherein component (b) is a carboxylated styrene butadiene latex binder.

4. The process as claimed in claim 1 wherein component (b) is present in the range of 4 to 12 parts.

5. The process as claimed in claim 1 wherein optional components (g) and (h) are absent.

6. The process as claimed in claim 1 wherein the viscosity of the ink prepared in step 1 at 32° C. is in the range of from 10 to 14 mPas when measured using a Brookfield DV2T with the SC4-18 spindle at 150 rpm.

7. The process as claimed in claim 1 wherein the viscosity of the ink prepared in step 1 at 32° C. is in the range of from 4 to 8 mPas when measured using a Brookfield DV2T with the SC4-18 spindle at 150 rpm.

8. The process as claimed in any one of claim 1 wherein in step (III) the ink prepared in step (I) is printed on to a textile substrate using a ink jet printer with an ink re-circulating print-head.

9. The process as claimed in claim 1 which comprises one of more drying steps prior to curing.

10. An ink comprising
(a′) from 2 to 6 parts of a self-dispersible pigment which comprises a carboxy-functional dispersant crosslinked around a pigment core by a crosslinking agent having at least two groups selected from oxetane, carbodiimide, hydrazide, oxazoline, aziridine, isocyanate, N-methylol, keteneimine, isocyanurate and epoxy groups;
(b′) from 0 to 16 parts of a binder selected from one or more of an acrylic latex binder, a styrene acrylic latex binder and a styrene butadiene latex binder wherein the binder has a Tg in the range of from −25° C. to 35° C.;
(c′) from 5 to 15 parts of one or more water-miscible organic solvents
(d′) from 0.1 to 0.5 parts of a surfactant;
(e′) from 0.01 to 1 parts of biocide;
(f′) from 3 to 8 parts of a viscosity modifier;
(g′) the balance to 100 parts water: and
wherein the ink has a viscosity at 30° C. in the range of from 10 to 14 mPa s when measured using a Brookfield DV2T with the SC4-18 spindle at 150 rpm.

11. An ink comprising
(a″) from 2 to 6 parts of a self-dispersible pigment which comprises a carboxy-functional dispersant crosslinked around a pigment core by a crosslinking agent having at least two groups selected from oxetane, carbodiimide, hydrazide, oxazoline, aziridine, isocyanate, N-methylol, keteneimine, isocyanurate and epoxy groups;
(b″) from 0 to 16 parts of a binder selected from one or more of an acrylic latex binder, a styrene acrylic latex binder and a styrene butadiene latex binder wherein the binder has a Tg in the range of from −25° C. to 35° C.;
(c″) from 5 to 15 parts of one or more water-miscible organic solvents
(d″) from 0.1 to 0.5 parts of a surfactant;
(e″) from 0.01 to 1 parts of biocide;
(f″) from 0 to 5 parts of a viscosity modifier;
(g″) the balance to 100 parts water: and
wherein the ink has a viscosity at 30° C. in the range of from 4 to 8 mPa s when measured using a Brookfield DV2T with the SC4-18 spindle at 150 rpm.

12. A textile substrate printed by a process as described in claim 1.

13. An ink-jet printer ink container comprising an ink as described in claim 10.

14. An ink-jet printer with a re-circulating printer head containing an ink-jet printer ink container as described in claim 13.

15. An ink-set comprising two or more different coloured inks as described in claim 10.

16. A textile substrate printed with an ink as described in claim 10.
